(19) United States
(12) Patent Application Publication
(10) Pub. No.: US 2005/0261392 A1
(43) Pub. Date: Nov. 24, 2005

(54) Photocurable resin composition and optical material

(75) Inventors: Satochi Futami, Tsukiji (JP); Shingo Itai, Tsukiji (JP); Hideaki Takase, Tsukiji (JP); Takayoshi Tanabe, Tokyo (JP)

Correspondence Address: NIXON & VANDERHYE, PC, 901 NORTH GLEBE ROAD, 11TH FLOOR, ARLINGTON, VA, 22203, US

(73) Assignee: DSM IP ASSETS B.V., NETHERLANDS (NL)

(21) Appl. No.: 10/530,177

(22) PCT Filed: Oct. 3, 2003
(86) PCT No.: PCT/NL03/00679

§ 371 Date: Jul. 14, 2005

(30) Foreign Application Priority Data
Oct. 8, 2002 (JP) JP2002-294726

(51) Int. Cl. C08G 2/00

(52) U.S. Cl. 522/178

(57) ABSTRACT

To provide a photocurable liquid resin composition that can produce cured products exhibiting a high refractive index, good shape restorability, and superior adhesion to substrates. The photocurable resin composition comprises (A) 20-80 wt % of a urethane (meth) acrylate obtained by reacting a polyether polyol having an alkyleneoxy structure in the molecule, an organic polyisocyanate compound, and a (meth) acrylate containing a hydroxyl group, (B) 10-70 wt % of a monofunctional ethylenically unsaturated compound, (C) 5-25 wt % of a (meth) acrylate monomer having four or more functional groups, and (D) 0.1-10 wt % of a photoinitiator. Cured products are useful for forming an optical part such as a lens of a lens sheet or a back light using the lens sheet.

The present invention relates to a photocurable resin composition and an optical part. More particularly, the present invention relates to a photocurable resin composition useful for forming an optical part such as a lens of a lens sheet or a back light using such a lens sheet, and to an optical part.

Conventionally, lenses such as a Fresnel lens and a lenticular lens are manufactured by using a press-forming process or a casting process. However, these processes require a long period of time for manufacturing a lens, thereby resulting in poor productivity.

In order to solve this problem, a method of manufacturing lenses by using a UV-curable resin has been studied in recent years. In more detail, a UV-curable resin composition is poured between a mold having a lens shape and a transparent resin substrate, and the composition is cured by applying ultraviolet rays from the side of the substrate, whereby a lens can be manufactured in a short period of time. Accompanied by a decrease in the thickness and an increase in the size of projection TVs and video projectors in recent years, various types of resins for forming a lens have been proposed and studied in order to deal with various lens properties such as an increase in refractive index and mechanical properties.

For example, a UV-curable resin composition for a transparent screen including (A) a urethane (meth)acrylate obtained by reacting (a) a diol compound obtained by reacting bisphenol A with ethylene oxide and the like, (b) a diol compound having a molecular weight of 200 or less, (c) an organic polyisocyanate, and (d) a (meth)acrylate containing a hydroxyl group, (B) a compound containing an ethylenically unsaturated group other than the component (A), and (C) a photoinitiator is disclosed for example in Japanese Patent Application Laid-open No. 5-2554363.

However, such a conventional UV curable resin composition cannot produce a cured product which satisfies properties required for lenses, such as deformation resistance and shape restorability in the applications for transparent screens of which brightness is more and more increased and the thickness is more and more decreased.

Accordingly, an object of the present invention is therefore to provide a photocurable resin composition capable of producing a cured product which is rarely deformed and excels in shape restorability, and an optical part.

The present inventors have conducted extensive studies to solve the problems of a conventional resin composition. As a result, the present inventors have found that an optical part, in particular, transparent screens such as a Fresnel lens and a lenticular lens which is rarely deformed and excels in shape restorability can be obtained by producing a cured product by using a photocurable resin composition comprising a specific urethane (meth)acrylate, a monofunctional ethylenically unsaturated compound, a (meth)acrylate monomer having four or more functional groups, and a photoinitiator.

Specifically, the present invention provides a photocurable resin composition comprising (A) 20-80 wt % of a urethane (meth)acrylate obtained by reacting a polyether polyol having an alkyleneoxy structure in the molecule, an organic polyisocyanate compound, and a (meth)acrylate containing a hydroxyl group, (B) 10-70 wt % of a monofunctional ethylenically unsaturated compound, (C) 5-25 wt % of a (meth)acrylate monomer having four or more functional groups, and (D) 0.1-10 wt % of a photoinitiator.

The component (A) of the photocurable resin composition of the present invention is a urethane (meth)acrylate produced by reacting a polyether polyol having an alkyleneoxy structure in the molecule, an organic polyisocyanate compound, and a (meth)acrylate containing a hydroxyl group.

Each component used for preparing the urethane (meth)acrylate (A) will be described below.

Examples of the polyether polyol having an alkyleneoxy structure in the molecule include polyethylene glycol, polypropylene glycol, polytetramethylene glycol, polyhexamethylene glycol, polyheptamethylene glycol, and polydecamethylene glycol. Of these, polytetramethylene glycol is preferable.

In addition, a polyether diol produced by ring-opening copolymerization of two or more ion-polymerizable cyclic compounds can be preferably used as the polyether polyol having an alkyleneoxy structure in the molecule. As examples of the ion-polymerizable cyclic compound, cyclic ethers such as ethylene oxide, propylene oxide, butene-1-oxide, isobutene oxide, 3,3-bischloromethyloxetane, tetrahydrofuran, 2-methyltetrahydrofuran, 3-methyltetrahydrofuran, dioxane, trioxane, tetraoxane, cyclohexene oxide, styrene oxide, epichlorohydrin, glycidyl methacrylate, allyl glycidyl ether, allyl glycidyl carbonate, butadiene monoxide, isoprene monoxide, vinyl oxetane, vinyl tetrahydrofuran, vinyl cyclohexene oxide, phenyl glycidyl ether, butyl glycidyl ether, and glycidyl benzoate can be given.

As specific examples of the combinations of at least two ion-polymerizable cyclic compounds, binary copolymers of tetrahydrofuran and propylene oxide, tetrahydrofuran and 2-methyltetrahydrofuran, tetrahydrofuran and 3-methyltetrahydrofuran, tetrahydrofuran and ethylene oxide, and butene-1-oxide and ethylene oxide, and ternary copolymers of tetrahydrofuran, butene-oxide, and ethylene oxide, and tetrahydrofuran, butene-1 -oxide, and ethylene oxide can be given.

Polyether diols obtained by the ring-opening copolymerization of these ion-polymerizable cyclic compounds with cyclic imines such as ethyleneimine, cyclic lactones such as □-propyolactone or glycolic acid lactide, or dimethylcyclopolysiloxanes may be used.

The ring-opening copolymer of these ion-polymerizable cyclic compounds may be either a random copolymer or a block copolymer.

Examples of commercially available products of the above polyether polyols include PTMG650, PTMG1000, PTMG2000 (manufactured by Mitsubishi Chemical Corp.), PPG700, PPG1000, EXCENOL2020, 1020 (manufactured by Asahi Glass Urethane Co., Ltd.), PEG1000, UNISAFE DC1100, DC1800 (manufactured by Nippon Oil and Fats Co., Ltd.), PTG650, PTG1000, PTG2000, PTG3000, PPTG2000, PPTG1000, PTGL1000, PTGL2000 (manufactured by Hodogaya Chemical Co., Ltd.), and Z-3001-4, Z-3001-5, PBG2000, PBG2000B (manufactured by Daiichi Kogyo Seiyaku Co., Ltd.).

In addition, a diol compound of the following formula (2) can be preferably used as the polyether polyol having an alkyleneoxy structure in the molecule. 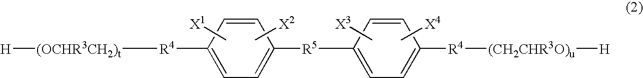
wherein R³ individually represents a hydrogen atom or a methyl group, R⁴ individually represents an oxygen atom or sulfur atom, R⁵ is a group —CH₂—, —C(CH₃)₂—, —S—, —SO—, or —SO₂—, X¹ to X⁴ individually represent a hydrogen atom, methyl group, or bromine atom, and t and u individually represent an integer from 0 to 9. t and u in the formula (2) is more preferably 1-9.

As examples of the diol of the formula (2), an ethylene oxide addition product of bisphenol A (t=u=1.3), ethylene oxide addition product of bisphenol A (t=u=2), ethylene oxide addition product of bisphenol A (t=u=5), propylene oxide addition product of bisphenol A (t=u=1.1), propylene oxide addition product of bisphenol A (t=u=1.5), propylene oxide addition product of bisphenol A (t=u=3), ethylene oxide addition product of bisphenol F (t=u=2), ethylene oxide addition product of bisphenol F (t=u=4), propylene oxide addition product of bisphenol F (t=u=2), ethylene oxide addition product of bisphenol S (t=u=2), propylene oxide addition product of bisphenol S (t=u=2), and ethylene oxide addition product of tetrabromobisphenol A (t=u=2) can be given.

The polystyrene-reduced number average molecular weight of the diol of the formula (2) is preferably 1,000 or less.

As examples of commercially available products of the diol of the formula (2), DA-400, DA-550, DA-700, DB-400, DB-530, DB-900, DAB-800 (manufactured by Nippon Oil and Fats Co., Ltd.) can be given.

These polyether polyols may be used either individually or in combinations of two or more. Both combinations of different polyether polyols in one urethane (meth)acrylate or in different urethane (meth)acrylates are possible.

As examples of the organic polyisocyanate compound, 2,4-tolylene diisocyanate, 2,6-tolylene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, and 4,4′-biphenylene diisocyanate can be given. Of these, 2,4-tolylene diisocyanate, 2,6-tolylene diisocyanate, 1,3-xylylene diisocyanate, and 1,4-xylylene diisocyanate are particularly preferable. These organic polyisocyanate compounds may be used either individually or in combinations of two or more.

Given as examples of the hydroxyl group-containing (meth)acrylate compound are (meth)acrylate compounds such a compound are 2-hydroxyethyl(meth)acrylate, 2-hydroxypropyl (meth)acrylate, 2-hydroxybutyl(meth)acrylate, 2-hydroxy-3-phenyloxypropyl(meth)acrylate, 1,4-butanediol mono(meth)acrylate, 2-hydroxyalkyl(meth)acryloyl phosphate, 4-hydroxycyclohexyl(meth)acrylate, 1,6-hexanediol mono(meth)acrylate, neopentyl glycol mono(meth)acrylate, trimethylolpropane di(meth)acrylate, trimethylolethane di(meth)acrylate, pentaerythritol tri(meth)acrylate, dipentaerythritol penta(meth)acrylate, and (meth)acrylates represented by the following structural formula (3): Of these, 2-hydroxy-3-phenyloxypropyl (meth)acrylate and 2-hydroxyethyl (meth)acrylate are particularly preferable. 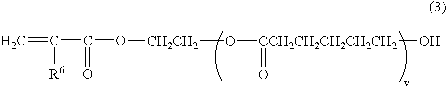
wherein R⁶ represents a hydrogen atom or a methyl group and v is an integer from 1 to 15.

Compounds obtained by the addition reaction of (meth)acrylic acid and a compound containing a glycidyl group such as alkyl glycidyl ether, allyl glycidyl ether, or glycidyl (meth)acrylate can also be used as the hydroxyl group-containing (meth)acrylate. These hydroxyl group-containing (meth)acrylates may be used either individually or in combinations of two or more. These hydroxylgroup-containing (meth)acrylates may be used to prepare one type of urethane (meth)acrylate or be used in the preparation of different urethane (meth)acrylates.

As the method of reacting the polyether polyol having an alkyleneoxy structure in the molecule, an organic polyisocyanate compound, and a hydroxyl group-containing (meth)acrylate for producing the urethane (meth)acrylate (A), (1) a method of charging all of the above polyether polyol, organic polyisocyanate compound, and hydroxyl group-containing (meth)acrylate and reacting these compounds all together; (2) a method of reacting the polyol and the organic polyisocyanate compound, and reacting the resulting product with the hydroxyl group-containing (meth)acrylate; (3) a method of reacting the organic polyisocyanate compound and the hydroxyl group-containing (meth)acrylate, and reacting the resulting product with the polyether polyol; and (4) a method of reacting the organic polyisocyanate compound and part of the hydroxyl group-containing (meth)acrylate, reacting the resulting product with the polyether polyol, and then reacting the resulting product with the rest of the hydroxyl group-containing (meth)acrylate can be given. Of these methods, the method of reacting the organic polyisocyanate compound and the hydroxyl group-containing (meth)acrylate, and reacting the resulting product with the polyether polyol is preferable for producing the urethane (meth)acrylate of the present invention.

When producing the urethane (meth)acrylate (A), it is preferable to add the polyether polyol, organic polyisocyanate compound, and hydroxyl group-containing (meth)acrylate so that isocyanate groups included in the organic polyisocyanate compound and hydroxyl groups included in the hydroxyl group-containing (meth)acrylate are respectively 1.1-1.5 equivalents and 0.1-0.5 equivalent for one equivalent of hydroxyl groups included in the polyether polyol.

When the polyether polyol contains a diol of the above formula (2) and another polyether polyol, these two polyether polyols are preferably included in one molecule of the urethane (meth)acrylate (A). In case where a diol according to formula (2) is used in combination with another polyether polyol, a preferable proportion is 10-70 wt % of the diol of the above formula (2) and to 30-90 wt % of another polyether polyol.

In the reaction for preparing the urethane (meth)acrylate (A), a urethanization catalyst such as copper naphthenate, cobalt naphthenate, zinc naphthenate, di-n-butyltin dilaurate, triethylamine, and triethylenediamine-2-methyltriethyleneamine is usually used in an amount from 0.01 to 1 wt % of the total weight of the reactants. The reaction is carried out preferably at 10-90° C., and particularly preferably at 30-80° C.

The number average molecular weight of the urethane (meth)acrylate (A) is preferably from 1,000 to 20,000, and particularly preferably from 1,500 to 15,000. If less than 1,000, the Young's modulus of the cured product produced by curing the resin composition increases extremely, thereby causing a break or crack when used as a lens. If more than 20,000, handling of the resin composition may become difficult due to the increased viscosity.

The amount of the component (A) added to the composition is preferably 20-80 wt %, and particularly preferably 30-70 wt %. The lower limit of this range must be observed for providing the cured product with appropriate mechanical properties such as mechanical strength and toughness, properties of preventing a break or crack when used as a lens sheet, and properties of ensuring easy restore of the lens shape when indented. The upper limit of this range must be observed for preventing processability or applicability from decreasing due to the increased viscosity of the composition.

The component (B) used in the photocurable resin composition of the present invention is a monofunctional ethylenically unsaturated compound, i.e. a compound having only one ethylenically unsaturated bond per molecule. As the component (B), vinyl monomers such as N-vinylpyrrolidone, N-vinylcaprolactam, vinylimidazole, and vinylpyridine; (meth)acrylate monomers such as isobornyl (meth)acrylate, bornyl (meth)acrylate, tricyclodecanyl (meth)acrylate, dicyclopentanyl (meth)acrylate, dicyclopentenyl (meth)acrylate, cyclohexyl (meth)acrylate, benzyl (meth)acrylate, 4-butylcyclohexyl (meth)acrylate, acryloylmorpholine, 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate, isostearyl (meth)acrylate, tetrahydrofurfuryl (meth)acrylate, butoxyethyl (meth)acrylate, ethoxydiethylene glycol (meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, methoxypolypropylene glycol (meth)acrylate, diacetone(meth)acrylamide, isobutoxymethyl(meth)acrylamide, N,N-dimethyl(meth)acrylamide, t-octyl(meth)acrylamide, dimethylaminoethyl (meth)acrylate, diethylaminoethyl (meth)acrylate, and 7-amino-3,7-dimethyloctyl (meth)acrylate; N,N-diethyl (meth)acrylamide, N,N-dimethylaminopropyl (meth)acrylamide, hydroxybutyl vinyl ether, lauryl vinyl ether, cetyl vinyl ether, and 2-ethylhexyl vinyl ether can be given. Of these, preferable compounds are (meth)acrylate monomers such as lauryl acrylate. These compounds may be used either individually or in combinations of two or more.

In addition, a monofunctional (meth)acrylate represented by the following formula (1) is particularly preferable for use as the component (B) to adjust the refractive index of the cured product. 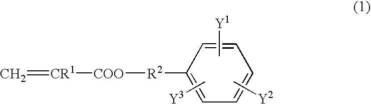
wherein R¹ represents a hydrogen atom or a methyl group, R² represents —(CH₂CH₂O)ₚ—, —(CH(CH₃)CH₂O)_{q}—, or —CH₂CH(OH)CH₂O— (wherein p and q are integers from 1 to 5), and Y¹ to Y³ individually represent a hydrogen atom, a bromine atom, an alkyl group having 1-10 carbon atoms, a phenyl group, or —C(CH₃)₂C₆H₅.

As specific examples of the monofunctional (meth)acrylate of the formula (1), phenoxyethyl (meth)acrylate, phenoxy-2-methylethyl (meth)acrylate, phenoxyethoxyethyl (meth)acrylate, 3-phenoxy-2-hydroxypropyl (meth)acrylate, 2-phenylphenoxyethyl (meth)acrylate, 4-phenylphenoxyethyl (meth)acrylate, 3-(2-phenylphenyl)-2-hydroxypropyl (meth)acrylate, (meth)acrylate of p-cumylphenol which is reacted with ethylene oxide, 2-bromophenoxyethyl (meth)acrylate, 2,4-dibromophenoxyethyl (meth)acrylate, 2,4,6-tribromophenoxyethyl (meth)acrylate, and phenoxytetraethylene glycol (meth)acrylate can be given. Of these, phenoxyethyl (meth)acrylate, phenoxyethoxyethyl (meth)acrylate, (meth)acrylate of p-cumylphenol reacted with ethylene oxide, 2,4,6-tribromophenoxyethyl (meth)acrylate, phenoxytetraethylene glycol (meth)acrylate, and the like are particularly preferable.

As examples of commercially available products of the component (B), LA, IBXA, Viscoat #190, #2000 (manufactured by Osaka Organic Chemical Industry Co., Ltd.), Light Acrylate EC-A, PO-A, NP-4EA, NP-8EA, HOA-MPL (manufactured by Kyoeisha Chemical Co., Ltd.), KAYARAD TC1 1OS, R629, R644 (manufactured by Nippon Kayaku Co., Ltd.), FA-511A, 512A, 513A (manufactured by Hitachi Chemical Co., Ltd.), VP (manufactured by BASF), and ACMO, DMM, DMAPAA (manufactured by KOHJIN Co., Ltd.) can be given. In addition, Aronix Ml 10, M101, M5700, TO-1317 (manufactured by Toagosei Co., Ltd.), Viscoat #192, #193, #220, 3BM (manufactured by Osaka Organic Chemical Industry Co., Ltd.), NK Ester AMP-10G, AMP-20G (manufactured by Shin-Nakamura Chemical Co., Ltd.), Light Acrylate PO-A, P-200A, Epoxy Ester M-600A (manufactured by Kyoeisha Chemical Co., Ltd.), PHE, CEA, PHE-2, BR-31, BR-31 M, BR-32 (manufactured by Daiichi Kogyo Seiyaku Co., Ltd.), and the like can be given as particularly preferable products.

The component (B) includes at least one monofunctional (meth)acrylate of which the homopolymer has a glass transition temperature of −5° C. or less, preferably −10° C. or less, and particularly preferably −15° C. or less. Such a monofunctional (meth)acrylate can improve adhesiveness.

The amount of the component (B) added to the composition is preferably 10-70 wt %, and particularly preferably 20-60 wt %. The lower limit of this range is specified for providing both adhesion to substrates and a refractive index. The upper limit of this range is specified for ensuring sufficient mechanical properties and applicability.

The component (C) used in the photocurable resin composition of the present invention is a (meth)acrylate monomer having four or more functional groups.

Of these, monomers such as ditrimethylolpropane tetra(meth)acrylate, pentaerythritolethoxy tetra(meth)acrylate, pentaerythritol tetra(meth)acrylate, dipentaerythritol penta(meth)acrylate, dipentaerythritolhydroxy penta(meth)acrylate, and dipentaerythritol hexa(meth)acrylate, as well as compounds prepared by introducing alkylene oxide or caprolactone in the main chain of these monomers are preferable. Dipentaerythritol hexa(meth)acrylate is particularly preferable for providing the product with excellent shape restorability.

As examples of commercially available products of the component (C), Viscoat #400 (manufactured by Osaka Organic Chemical Industry Co., Ltd.), Light Acrylate PE-4A, DTMP-4A, DPE-6A (manufactured by Kyoeisha Chemical Co., Ltd.), KAYARAD T1420 (T), DPHA, DPCA-20, DPCA-30, DPCA-60, DPCA-12, SR-295, SR-355, SR-399E, SR-494 (manufactured by Nippon Kayaku Co., Ltd.), and Aronix M-400, M-408, M-450 (manufactured by Toagosei Co., Ltd.) can be given.

The amount of the component (C) added to the composition is preferably 5-25 wt %, and particularly preferably 10-25 wt %. The above lower limit of the amount is preferable in view of suppressing a decrease in Young's modulus. The upper limit is preferable in view of maintaining high shape restorability of lenses.

The photocurable resin composition of the present invention is cured by radiation. Radiation used herein includes ionizing radiation such as infrared rays, visible rays, ultraviolet rays, X-rays, electron beams, α-rays, β-rays, and γ-rays, for example. In this instance, a photoinitiator is required as the component (D) for curing the composition. In addition, a photosensitizer is optionally added. As the photoinitiator, any compound which decomposes upon irradiation and generates radicals to initiate the polymerization can be used. Examples of such compounds include acetophenone, acetophenone benzyl ketal, 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanthone, diethylthioxanthone, 2-isopropylthioxanthone, 2-chlorothioxanthone, 2-methyl-1-[4-(methylthio)phenyl]-2-morpholino-propan-1-one, 2,4,6-trimethylbenzoyl diphenylphosphine oxide, and bis-(2,6-dimethoxybenzoyl)-2,4,4-trimethylpentylphosphine oxide. Of these, 1-hydroxycyclohexyl phenyl ketone is preferable.

As examples of commercially available products of the component (D), Irgacure184, 369, 651, 500, 819, 907, 784, 2959, CGI-1700, CGI-1750, CGI-1850, CG24-61, Darocur 1116, 1173 (manufactured by Ciba Specialty Chemicals Co., Ltd.), Lucirin TPO, LR8893, LR8970 (manufactured by BASF), and Ubecryl P36 (manufactured by UCB) can be given.

As examples of the photosensitizer, triethylamine, diethylamine, N-methyldiethanoleamine, ethanolamine, 4-dimethyl aminobenzoic acid, methyl 4-dimethylaminobenzoate, ethyl 4-dimethylaminobenzoate, and isoamyl 4-dimethylaminobenzoate can be given. As examples of commercially available products of the photosensitzer, Ubecryl P102, 103, 104, 105 (manufactured by UCB can be given.

The optimum amount of the component (D) used to cure the resin composition of the present invention is from 0.01 to 10 wt %, and preferably from 0.5 to 7 wt % of the total amount of the composition. The above upper limit is desirable in view of ensuring superior curing characteristics of the composition, mechanical and optical characteristics of cured products, and handling easiness. The lower limit is desirable for preventing decrease in the curing speed.

A heat-polymerization initiator can be optionally added when curing the resin composition of the present invention. Peroxides and azo compounds can be given as examples of preferable heat-polymerization initiators. Specific examples include benzoyl peroxide, t-butyl peroxybenzoate, azobisisobutyronitrile, and the like.

Triphenylphosphine may further be incorporated in the resin composition of the present invention as a compound (E) to improve adhesiveness. The amount of triphenylphosphine to be added is preferably 0.5 to 5 wt % of the total weight of the composition. If less than 0.5 wt %, the adhesion with a substrate is insufficient; if more than 5 wt %, Young's modulus decreases, which may result in crushing of the products.

Curable oligomers or polymers other than the above components may be added to the resin composition of the present invention insofar as the characteristics of the resin composition are not adversely affected. As examples of such curable oligomers or polymers, polyurethane (meth)acrylate other than the component (A), polyester (meth)acrylate, epoxy (meth)acrylate, polyamide (meth)acrylate, siloxane polymers having a (meth)acryloyloxy group, and reactive polymers produced by reactng a copolymer of glycidyl (meth)acrylate and other polymerizable monomers with (meth)acrylic acid can be given. A difuncfional or trifunctional (meth)acrylate such as pentaerythritol tri(meth)acrylate, trimethylolpropane tri(meth)acrylate, and glycerol tri(meth)acrylate may also be added.

In addition to the above components, additives such as antioxidants, UV absorbers, light stabilizers, silane coupling agents, coating surface improvers, heat-polymerization inhibitors, leveling agents, surfactants, coloring agents, preservatives, plasticizers, lubricants, solvents, fillers, aging preventives, and wettability improvers may optionally be added. Examples of antioxidants include Irganox1010, 1035, 1076, 1222 (manufactured by Ciba Specialty Chemicals Co., Ltd.), Antigene P, 3C, FR, Sumilizer GA-80 (manufactured by Sumitomo Chemical Industries Co., Ltd.), and the like; examples of UV absorbers include Tinuvin P, 234, 320, 326, 327, 328, 329, 213 (manufactured by Ciba Specialty Chemicals Co., Ltd.), Seesorb 102, 103, 110, 501, 202, 712, 704 (manufactured by Sypro Chemical Co., Ltd.), and the like; examples of light stabilizers include Tinuvin 292, 144, 622LD (manufactured by Ciba Specialty Chemicals Co., Ltd.), Sanol LS770 (manufactured by Sankyo Co., Ltd.), Sumisorb TM-061 (manufactured by Sumitomo Chemical Industries Co., Ltd.), and the like; examples of silane coupling agents include □-aminopropyltriethoxysilane, □-mercaptopropyltrimethoxy-silane, and □-methacryloxypropyltrimethoxysilane, and commercially available products such as SH6062, SH6030 (manufactured by Toray-Dow Corning Silicone Co., Ltd.), and KBE903, KBE603, KBE403 (manufactured by Shin-Etsu Chemical Co., Ltd.); examples of coating surface improvers include silicone additives such as dimethylsiloxane polyether and commercially available products such as DC-57, DC-190 (manufactured by Dow-Coming), SH-28PA, SH-29PA, SH-30PA, SH-190 (manufactured by Toray-Dow Corning Silicone Co., Ltd.), KF351, KF352, KF353, KF354 (manufactured by Shin-Etsu Chemical Co., Ltd.), and L-700, L-7002, L-7500, FK-024-90 (manufactured by Nippon Unicar Co., Ltd.).

The resin composition of the present invention is produced by mixing the above components by using a conventional method. Viscosity of the resin composition of the present invention thus prepared is usually from 200 to 50,000 mPa.s/25° C., and preferably from 500 to 30,000 mPa.s at 25° C. If the viscosity of the composition is too great, coating may become uneven or crinkles may occur when forming a lens, or a desired thickness of the lens may not be obtained, whereby performance of the lens may be insufficient. If the viscosity is too low, it is difficult to control the thickness of the lens, whereby a lens having a uniform thickness may not be formed.

The resin composition of the present invention is preferably used for fabricating optical parts.

It is particularly preferable that the cured product prepared by curing the resin composition of the present invention by radiation have the following properties.

One of the properties is possession of at least one peak or shoulder in a temperature range of 35° C. or less, preferably 35° C. or less, in a temperature dependency curve of a loss tangent obtained when an oscillation frequency of 10 Hz is applied to the cured product using a dynamic viscoelasticity measuring device. If the resin composition that can produce a cured product satisfying this property is used for forming a transparent screen such as a lens sheet, the product can instantaneously restore the original shape when indented. In addition, excellent adhesion to substrate, superior shape restorability, and appropriate mechanical properties are provided.

The refractive index of the cured product at 25° C. is preferably 1.53 or more, and still more preferably 1.54 or more. If the refractive index is less than 1.53, a transparent screen formed from the resin composition may exhibit insufficient frontal brightness.

In addition, the Young's modulus determined from the stress to produce a distortion of 2% when the cured product is pulled at a rate of 10 mm/min (hereinafter referred to as “Young's modulus”) is preferably from 10 to 60 MPa, and more preferably 15 to 55 MPa. If the Young's modulus is more than 60 MPa, projected parts of the lens may be broken or be scraped when using the resin composition as a lens sheet, whereby the intended lens performance cannot be exhibited. If the Young's modulus is less than 10 MPa, when the lenses are layered, the projected parts of the lens may be indented to a degree whereby it is no longer possible to restore the original configuration, and the intended lens performance cannot be exhibited.

In addition, it may become so difficult detaching a lens from a mold that the production of the lens may be trouble some.

The cured product obtained by curing the composition of the present invention is useful for fabricating optical parts, for example, lens parts such as prism lens sheets used for backlight of liquid crystal displays, Fresnel lens sheet used for screens of projection TVs, and lenticule lens sheets, as well as back lights using such sheets.

### EXAMPLES

The present invention is described below in more detail by examples. However, the present invention is not limited to these examples.

### Synthesis Example 1

### Synthesis Urethane Acrylate

A reaction vessel equipped with a stirrer was charged with 28.50 wt % of 2,4-tolylene diisocyanate, 0.08 wt % of di-n-butyltin dilaurate, and 0.03 wP/O of 2,6-di-t-butyl-p-cresol. The mixture was cooled to 5-10° C. 19.00 wt % of 2-hydroxyethyl acrylate was added dropwise at 30° C. or lower while stirring. After the addition, the mixture was allowed to react at 30° C. for one hour. 52.50 wt % of polytetramethylene glycol with a number average molecular weight of 647 was then added and the mixture was reacted at 50-70° C. for two hours. The reaction was terminated when the residual isocyanate was 0.1 wt % or less. The resulting urethane acrylate is referred to as “A-1”.

### Example 1

A reaction vessel equipped with a stirrer was charged with 36 wt % of A-1 obtained in the Synthesis Example 1 as the component (A), 14 wt % of phenoxyethyl acrylate, 16 wt % of phenoxytetraethylene glycol acrylate, and 19 wt % of ethylene oxide-addition p-cumylphenol acrylate as the component (B), 10 wt % of dipentaerythritol hexacrylate as the component (C), 3 wt % of 1-hydroxycyclohexyl phenyl ketone as the component (D), and 2 wt % of triphenylphosphine as the component (E). The mixture was stirred for one hour while maintaining the liquid temperature at 50-60° C. to obtain a curable liquid resin composition with a viscosity of 3,100 mPa.s/25° C.

### Examples 2-4 and Comparative Example 1

The components shown in Table 1 were charged to a reaction vessel to prepared curable liquid resin compositions in the same manner as in Example 1. The amount of the components is shown by part by weight in Table 1.

Evaluation Methods

Test specimens were prepared using the curable liquid resin compositions obtained in the above examples according to the method described below. The viscosity, refractive index, adhesion to substrates during continuous photocuring, Young's modulus, tans maximum temperature, and shape restorability of the test specimens were measured according to the following methods.

(1) Viscosity

The viscosity at 25° C. was measured using a rotational viscometer according to JIS K7117.

The curable liquid resin compositions were applied to a glass plate by using a 250 μm thickness applicator. The compositions were then exposed to ultraviolet rays using a 3.5 kW metal halide lamp (SMX-3500/F-OS, manufactured by ORC Co., Ltd.) at a dose of 2.5 J/cm² in air to form cured films having a thickness of about 200 μm.

(2) Refractive Index

The refractive index at 25° C. of the test specimen prepared above was measured according to JIS K7105 using an Abbe's refractometer (manufactured by Atago Co., Ltd.).

(3) Young's Modulus:

The cured film was conditioned for 12 hours at 23° C. and 50% RH (relative humidity) and cut into strips of a 0.6 cm width to prepare test specimens. A stress (a) at 2% distortion (Δl) was measured at a tensile speed of 10 mm/min using a tensile tester manufactured by Shimadzu Corp. The Young's modulus defined by the following formula was calculated.
Young's modulus=σ/Δl
(4) tan δ Maximum Temperature

The cured film was conditioned for 12 hours at 23° C. and 50% RH (relative humidity) and cut into strips of a 0.3 cm width to prepare test specimens. A loss tangent (tans) was measured as an index for dynamic viscoelasticity using Rheovibron Model RHEO-1021 (a control section) and Rheovibron Model DDV-01FP (a measuring section), manufactured by Kabushiki Kaisha Orientech under the conditions of a temperature rise at a rate of 2° C./min, bench mark distance of 30 mm, vibration frequency of 10 Hz, vibration amplitude 10 mm, and measurement temperature range of −100° C. to 150° C. The temperature at which the loss tangent (tan δ) becomes the maximum was determined.

(5) Adhesion to Substrate

The curable liquid resin composition was charged to a space between a Fresnel lens mold and a substrate (10 cm×10 cm) with a thickness of 2 mm made from polymethyl methacrylate (PMMA) or methyl methacrylate-styrene copolymer (MS). The substrate was pressed to prepare a resin composition layer with a prescribed thickness. The resin layer was then cured by irradiating with ultraviolet rays at a dose of 1.0 J/cm² from the substrate side. The cured resin (hereinafter referred to as “lens substrate”) was removed from the mold by hand. The lens substrate removed was evaluated by measuring adhesiveness with the PMMA or MS substrate by a cross cut peeling test according to JIS K5400. A lens substrate in which no square was peeled from the PMMA or MS substrate but all adhered perfectly to the PMMA or MS substrate was evaluated as Good, a lens substrate in which a part of the squares was peeled from the PMMA or MS substrate was evaluated as Fair, and a lens substrate in which all the squares were peeled from the PMMA or MS substrate was evaluated as Bad.

(6) Restorability

A metal ball indenter with a diameter of 0.4 mm was pressed to the lens surface of the lens substrate removed from the lens mold with a 30 g load for one minute. A period of time required for the ball mark on the lens surface to disappear was measured. A lens substrate for which the ball mark disappeared within 10 minutes was evaluated as Good, a lens substrate for which the ball mark disappeared in more than 10 minutes but in one hour or less was evaluated as Fair, and a lens substrate for which the ball mark did not disappear after one hour was evaluated as Bad.

TABLE 1

| | | Example | | | | | | Comparative |
|---|---|---|---|---|---|---|---|---|
| | | 1 | 2 | 3 | 4 | 5 | 6 | Example 1 |
| Component (A) | A-1 (PTMG650/TH) | 37 | 37 | 37 | 37 | 36 | 36 | 37 |
| | B-1 (PHE) | 14 | | 15 | 3 | | 14 | 15 |
| | B-2 (PHE-4) | 16 | 31 | | 17 | 30 | | 16 |
| Component (B) | B-3 (M110) | 19 | 19 | 19 | 19 | 19 | 19 | 19 |
| | B-4 (Lauryl acrylate) | | | 16 | | | 16 | |
| Component (C) | C-1 (DPHA) | 10 | 10 | 10 | 22 | 10 | 10 | |
| Component (D) | D-1 (Irgacure 184) | 3 | 3 | 3 | 3 | 3 | 3 | 3 |
| Component (E) | E-1 (PPh3) | 2 | | | | 2 | 2 | |
| Other components | 4EGA | | | | | | | 10 |
| Properties of cured | Viscosity (mPa · s) | 2200 | 2500 | 2000 | 2700 | 2300 | 1800 | 2300 |
| product | Refractive index (n_{D}²⁵) | 1.547 | 1.546 | 1.533 | 1.540 | 1.548 | 1.535 | 1.546 |
| | Adhesion to substrate | | | | | | | |
| | /MS | Good | Good | Good | Good | Good | Good | Good |
| | /PMMA | Good | Good | Good | Good | Good | Good | Good |
| | Young's modulus (Mpa) | 33 | 28 | 33 | 60 | 23 | 28 | 9 |
| | tan□ maximum temperature (° C.) | 24 | 20 | 21 | 38 | 20 | 21 | 20 |
| | Restorability | Good | Good | Good | Good | Good | Good | Bad |

Each component shown in Table 1 is as follows.

Component (B):

B-1 (PHE): Phenoxyethyl acrylate (New Frontier PHE, manufactured by Daiichi Kogyo Seiyaku Co., Ltd., glass transition temperature (Tg) of homopolymer: −8° C.)

B-2 (PHE-4): Phenoxytetraethylene glycol acrylate (Aronix Ml 02, manufactured by Toagosei Co., Ltd., Tg of homopolymer: −18° C.)

B-3 (M110): 2-mol ethylene oxide-added p-cumylphenol acrylate (Mn=354, ARONIX M110, manufactured by Toagosei Co., Ltd., Tg of homopolymer: 37° C.)

B-4: Lauryl acrylate (LA, manufactured by Osaka Organic Chemical Industry Co., Ltd., Tg of homopolymer: −30° C.)

Component (C):

C-1 (DPHA): Dipentaerythritol hexaacrylate (Kayarad DPHA, manufactured by Nippon Kayaku Co., Ltd.)

Component (D):

D-1: 1-Hydroxycyclohexyl phenyl ketone (Irgacure 184, manufactured by Ciba Specialty Chemicals Co.)

Component (E):

E-1 (PPh3): Triphenylphosphine (manufactured by Hokko Chemical Industry Co., Ltd.) Other components:

4EGA: Tetraethylene glycol diacrylate (Light Acrylate 4EG-A, manufactured by Kyoeisha Chemical Co., Ltd.)

Effect of the Invention

The curable liquid resin composition of the present invention provides a cured product exhibiting a high refractive index, good shape restorability, and superior adhesion to substrates. The resin composition is suitable for manufacturing optical parts such as a lens sheet.

1. A photocurable resin composition comprising:
(A) 20-80 wt % of urethane (meth)acrylate obtained by the reaction of a polyether polyol compound having an alkyleneoxy structure in the molecule, an organic polyisocyanate compound, and a hydroxyl group-containing (meth)acrylate compound,
(B) 10-70 wt % of a monofunctional ethylenically unsaturated compound,
(C) 5-25 wt % of a (meth)acrylate monomer having four or more functional groups, and
(D) 0.1-10 wt % of a photoinitiator.

2. The photocurable resin composition according to claim 1, wherein the component (B) includes a monofunctional (meth)acrylate of which the homopolymer has a glass transition temperature of −5° C. or less.

3. The photocurable resin composition according to claim 1, wherein the component (B) includes a monofunctional (meth)acrylate of the following formula (1): 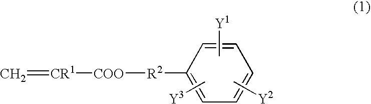
wherein R1 represents a hydrogen atom or a methyl group, R2 represents —(CH2CH2O)p-, —(CH(CH3)CH2O)q-, or —CH2CH(OH)CH2O— (wherein p and q are integers from 1 to 5), and Y1 to Y3 individually represent a hydrogen atom, a bromine atom, an alkyl group having 1-10 carbon atoms, a phenyl group, or —C(CH3)2C6H5.

4. The photocurable resin composition according to claim 1, further comprising triphenyl phosphine.

5. The photocurable resin composition according to claim 1, wherein a cured product of the photocurable resin composition has at least one peak or shoulder at a temperature of 35° C. or less in a temperature dependence curve of a loss tangent obtained from a temperature dependence measurement of dynamic viscoelasticity.

6. The photocurable resin composition according to claim 1, wherein a cured product obtained by curing the photocurable resin composition has a Young's modulus of 10-60 MPa.

7. The photocurable resin composition according to claim 1, wherein a cured product obtained by curing the photocurable resin composition has a refractive index of 1.53 or more at 25° C.

8. The photocurable resin composition according to claim 1, which is used for forming an optical part.

9. An optical part which is formed of a cured product of the photocurable resin composition according to claim 1.
